(19) United States
(12) Patent Application Publication
(10) Pub. No.: US 2009/0096344 A1
(43) Pub. Date: Apr. 16, 2009

(54) Sparkplugs and method to manufacture and assemble

(76) Inventors: Robert Lee Steigleman, JR., Mira Loma, CA (US); Jimmy Robert Allen, II, Corona, CA (US)

Correspondence Address: ROBERT LEE STEIGLEMAN JR., 5800 HAMNER AVE, SPACE #631, MIRA LOMA, CA, 91752, US

(21) Appl. No.: 12/231,130

(22) Filed: Aug. 29, 2008

Related U.S. Application Data
(60) Provisional application No. 60/998,265, filed on Oct. 10, 2007.

(51) Int. Cl. H01T 13/20; H01T 21/02

(52) U.S. Cl. 313/139; 445/7

(57) ABSTRACT

The invention is a spark plug having multiple precise spark gaps (G} with a donut shaped electrode (20) attached to the firing end of the central electrode (32), as well as a cylindrical ground sleeve (40) that is pressed on to the primary shell (36) of the spark plug. The electrode donut (20) is generally flat and laded out in a radial direction towards the ground prongs (42) that protrude up towards the firing end from the ground sleeve (40). In conjunction with their structure, allow for the generation of a spark from every single ground prong (42) on the ground sleeve (40). This is spark potential area (G). Such multiple spark potential area along with the electrode donut (20) and ground sleeve (40) relation provides a more rapid and complete combustion of the air-fuel mixture within the internal combustion engine, which, in turn, results in more torque and more horse power.

### CROSS-REFERENCE TO RELATED APPLICATIONS

This application claims the benefits of provisional patent application Ser. No. 60/998,265, Filed 2007 Oct. 10 by the present inventors, which is incorporated by reference here in.

### FEDERALLY SPONSORED RESEARCH

Not applicable

### SEQUENCE LISTINGS OR PROGRAMS

Not applicable

### BACKGROUND

1. Field

This application relates to the sparkplug of an internal combustion engine, and more particularly, to the efficiency of the spark ability, of that sparkplug. This application also relates to the manufacture and assembly, of that sparkplug.

2. Prior Art

In a 4 cycle internal combustion engine, the cycles are, starting at top dead center; this means that the piston is all the way at the top of the cylinder at the start of the cycle. The piston moves downward and the intake valve opens letting the air fuel mixture into the firing chamber, this is the intake cycle. When the piston reaches bottom dead center, the intake valve closes, and the piston moves up compressing the air fuel mixture, this is the compression cycle, and this creates a very fast moving wind storm type environment. When the piston reaches top dead center, the sparkplug will fire causing the compressed air fuel mixture to explode and force the piston downward, this is the power cycle. This is where the fuel is actually turned to kinetic energy that causes the internal combustion engine to operate. When the piston reaches bottom dead center, the exhaust valve will open and the piston will move upward and force the burnt air fuel mixture out of the firing chamber, which is 1 revolution of the internal combustion engine. 1 revolution happens, from 800 to over 10,000 times a minute this is called revolutions per minute or RPM'S.

The sparkplug will receive an electric charge of energy from the coil of the distributor system; this is called electro motive force this will cause the positive electrode to be energized with tens of thousands of volts. At that moment it tries to ionize a pathway to ground so as to let the electrons, from the ground, flow to the positive electrode, that flow of electrons is the spark.

Now do to the wind storm effect in the combustion chamber environment, the ionization of the pathway is impeded greatly do to the fact that the fast moving air fuel mixture blows the ionized path out and away from the ground. This happens several times before the pathway is finally established and the electrons can flow through the ionization path like electricity flows through a wire. This happens in less than 0.001 of a second.

The standard sparkplugs generally have a relatively small positive electrode and very little ground area, or multiple points of spark potential area for the ionization of the pathway to choose from. The ground prong is generally welded to the shell and protrudes up and over the positive electrode.

There have been many ideas to address these problems, ranging from good, but not complete, to poorly designed and manufactured. One idea is the U.S. Pat. No. 6,628,049 patent, and the U.S. Pat. No. 6,608,430 patent these are basically the same plug and are a variation of the U.S. Pat. No. 1,610,032 patent of 1926, there is the multiple, but small points of spark potential area, and extended reach with the ring but the spark is still happening under the cap between the points and ground ring, vertical to the center line of the sparkplug, and if all the points, or spark potential areas are not the exact physical distance apart, this will impede the establishment of the ionization path as well. There are many that address the rapidly moving air fuel mixture, by using port holes in the extension ring.

Other ideas address the spark potential area like the U.S. Pat. No. 5,731,655 patent but have no way of guiding the flow of the air fuel mixture in the direction that the spark is, and the spark is under the disk vertical to the center line of the sparkplug, as well.

The U.S. Pat. No. 3,958,144 patent of 1976 shows ground configurations, that have some variations of porting and have the spark at the top of the plug but some of these look arbitrary and would do little to direct the flow in the direction of the spark, and again if the distances of the spark potential area isn't exact it will impede the spark.

It is therefore an object of the preferred embodiments to increase the spark ability of the sparkplug by giving it more spark potential area, and/or, points of spark, that are the exact physical distance.

It is another object of the preferred embodiments to direct the rapidly moving air fuel mixture to flow in the direction away from the positive electrode so as to have greater possibility of ionization. The rapidly moving air fuel mixture will help push the ionization in the direction of the ground, instead of impeding it.

It is an object of the application to disclose the method of manufacture and assembly to make the spark potential area, less than 0.0005 of an inch, respectively to one another, and to precisely set the gaps. This is to ensure that the spark gaps are equal in physical distance, and set to the size that is required for a specific application.

### SUMMARY

In accordance with the preferred embodiments, there is provided multiple sparkplugs, to be used in various applications of the internal combustion engine, all with multiple points, and/or spark potential area, all with larger positive electrodes, all with unique structural, and construction element features, and will produce a spark horizontal to the center line of the sparkplug. These features will cause the spark to be at the very most top of the sparkplug, and in conjunction with the characteristics of the ground sleeves and the way they let the rapidly moving air fuel mixture flow in and around the spark potential area causes it to be faster. The thermo bonding of the positive electrode to the core electrode will create a positive charge, to add to the positive electrodes high voltage in the preferred embodiments of these inventions. These provisions in turn will cause the combustion to be faster and easier, this in turn will cause more torque and more house power for the internal combustion engine.

Also in accordance with the present invention there are a multiple number of assembly and manufacturing procedures to be used to achieve the preferred embodiments that are used in various applications of the internal combustion engine.

The multiple sparkplugs are different only in the fact that they are designed to perform with in the realms of a specific application but can still be used in an enormous number of applications.

### DRAWINGS

### Figures

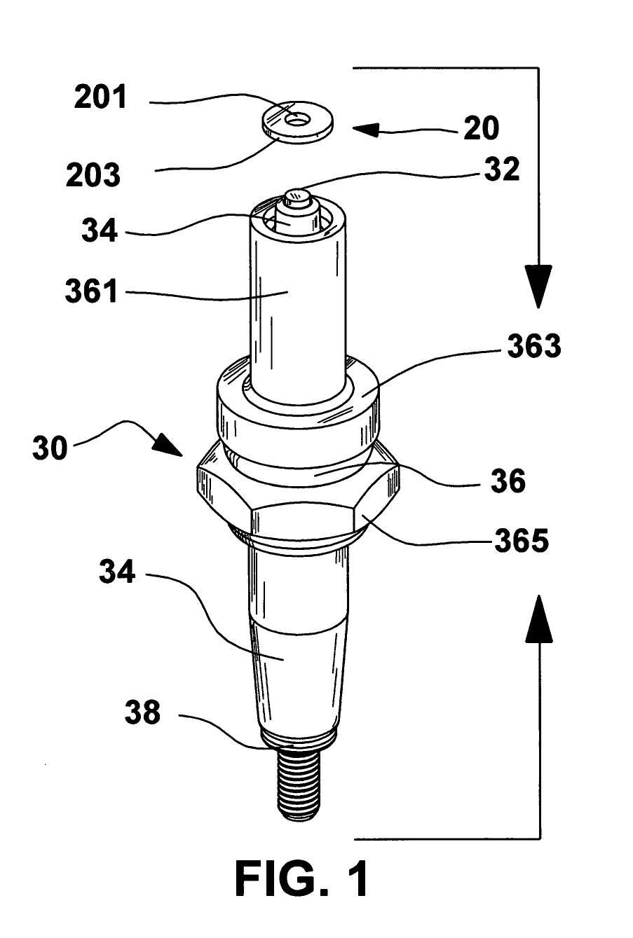

FIG. 1 is a perspective exploded view of the primary shell and insulator assembly and the electrode donut.

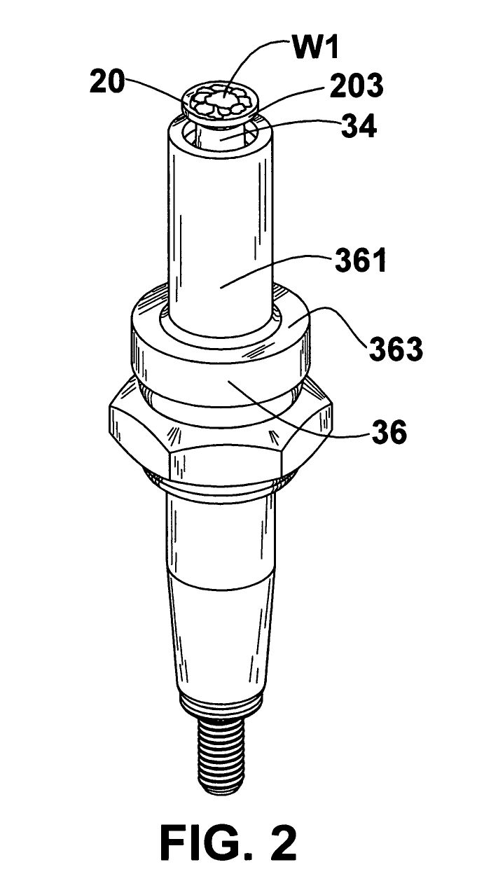

FIG. 2 is a perspective view of the primary shell and insulator assembly with electrode donut and weld.

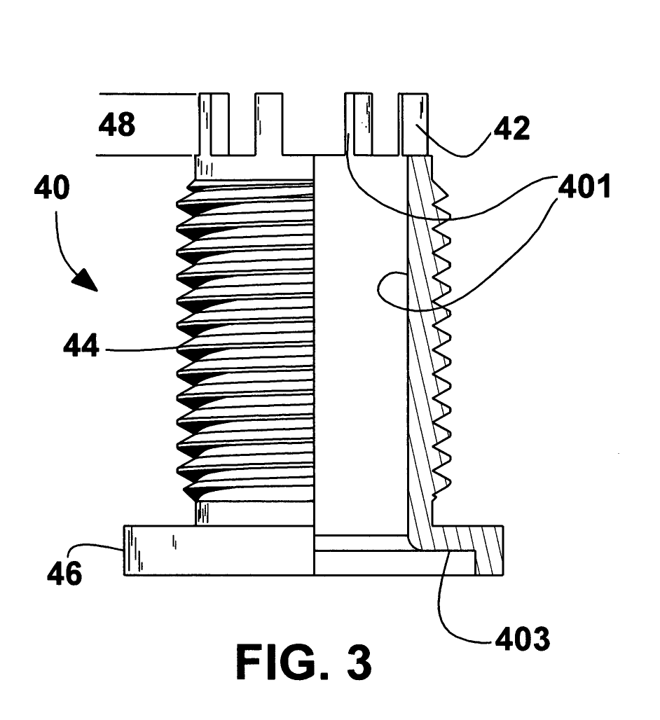

FIG. 3 is a front partial cross cut view of the ground sleeve.

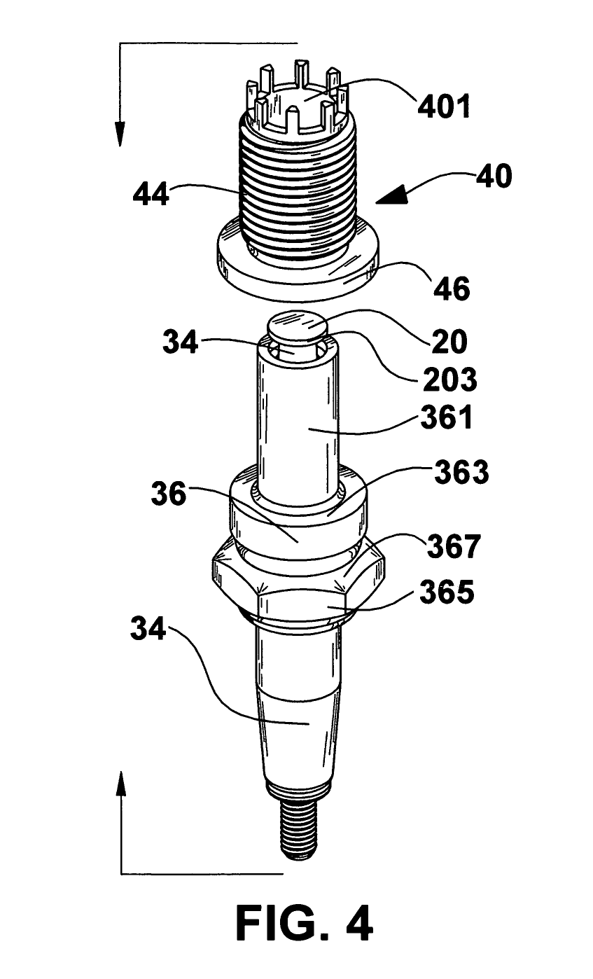

FIG. 4 is a perspective exploded view of the primary shell and insulator assembly and the ground sleeve.

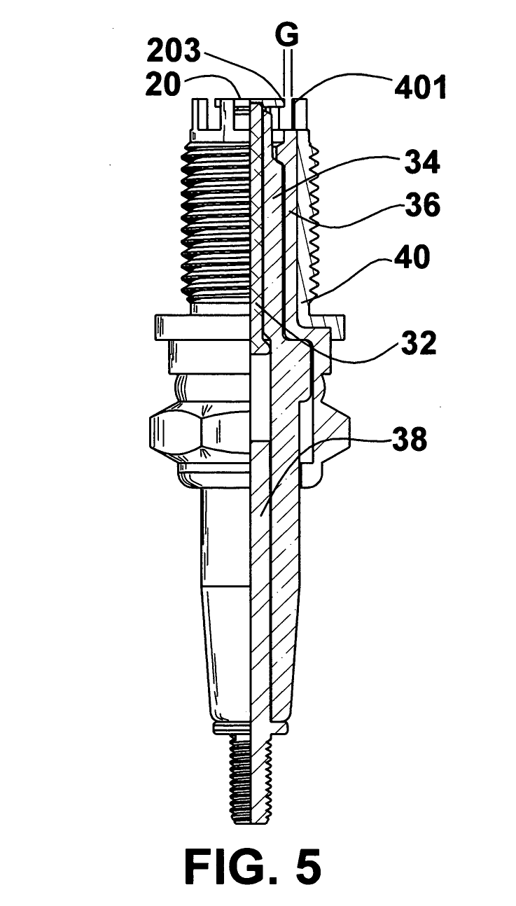

FIG. 5 is a front partial cross cut view of the primary shell and insulator assembly and the ground sleeve after assembly.

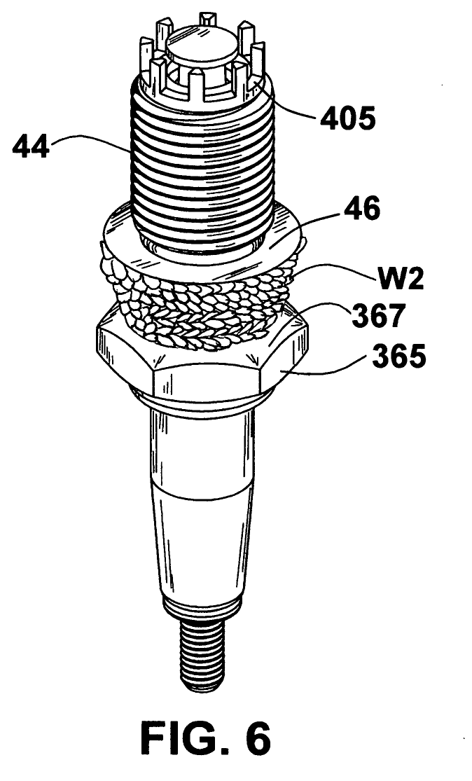

FIG. 6 is a perspective view of the assembled embodiment and the location of the body weld.

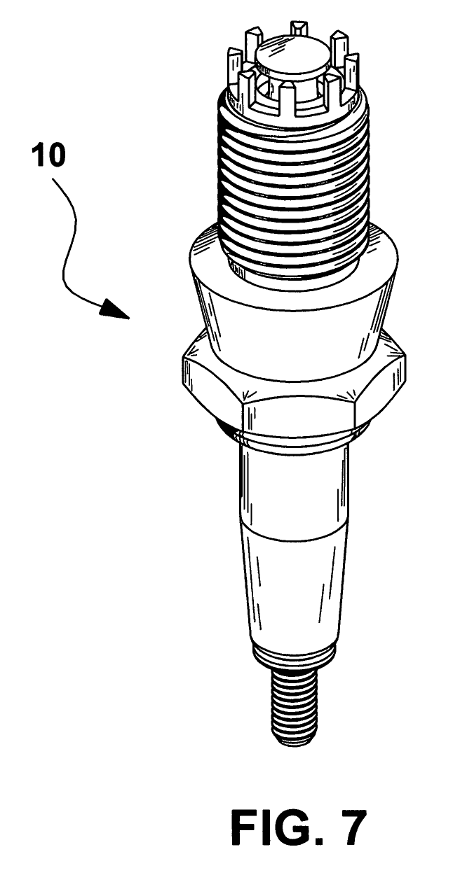

FIG. 7 is a perspective view of the preferred embodiment in its final state.

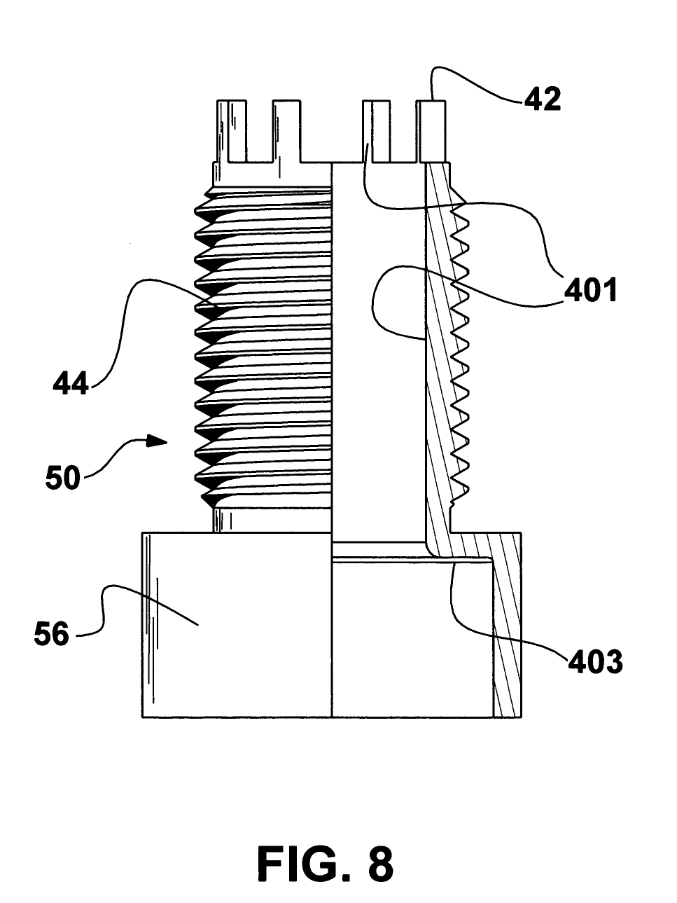

FIG. 8 is a front partial cross cut view of the ground sleeve.

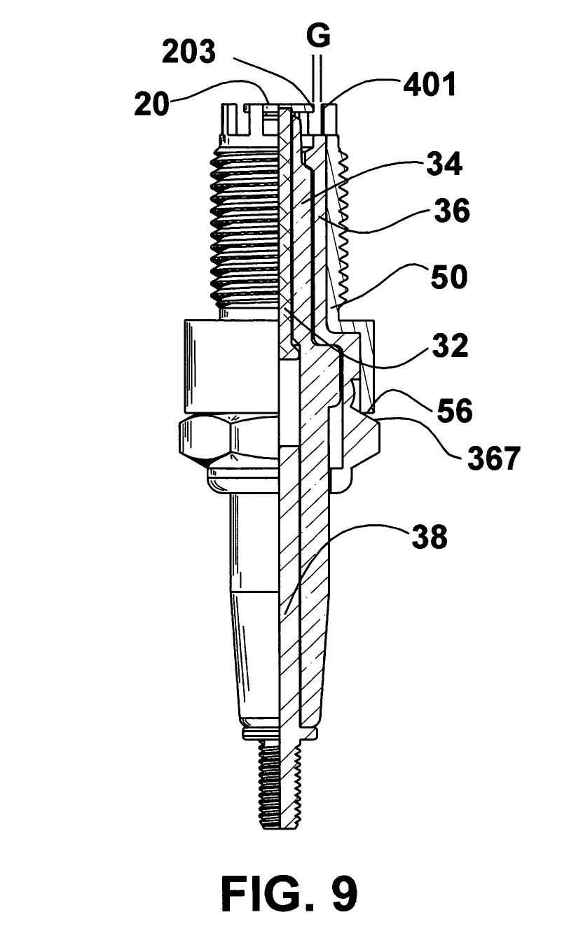

FIG. 9 is a front partial cross cut view of the primary shell and insulator assembly and the ground sleeve after assembly.

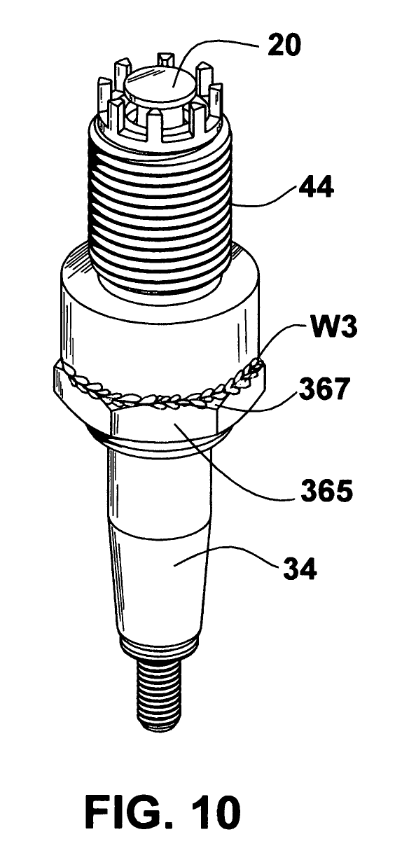

FIG. 10 is a perspective view of the assembled embodiment and the location of the body weld.

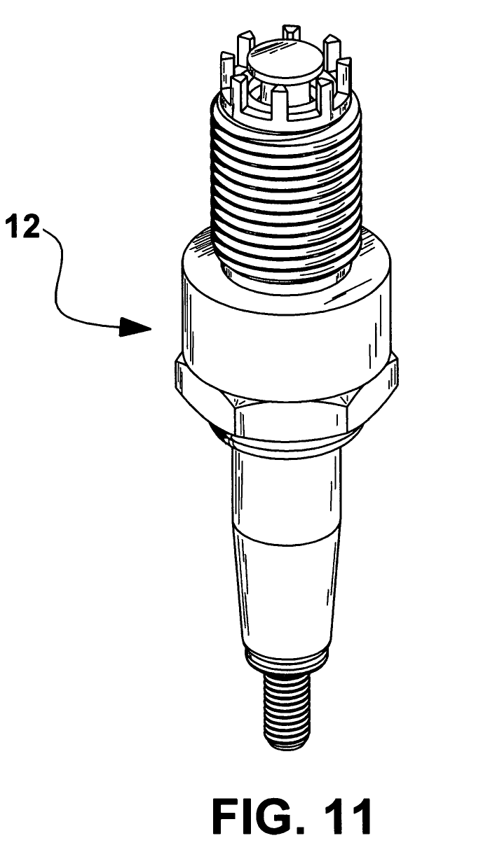

FIG. 11 is a perspective view of the preferred embodiment in its final state.

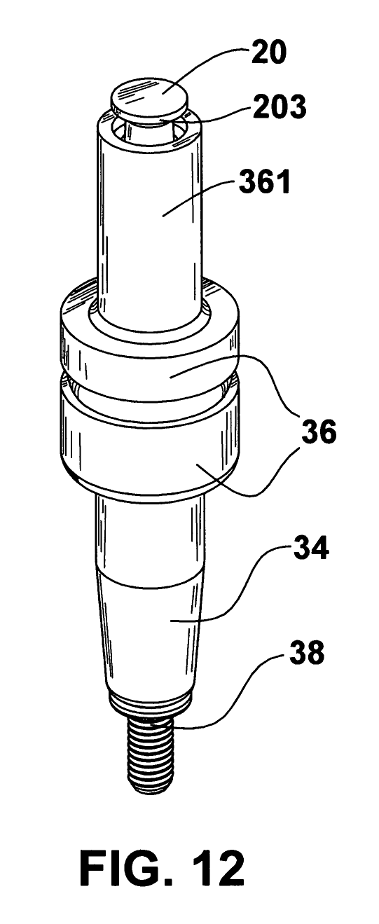

FIG. 12 is a perspective view of the primary shell and insulator assembly and the primary sell variation.

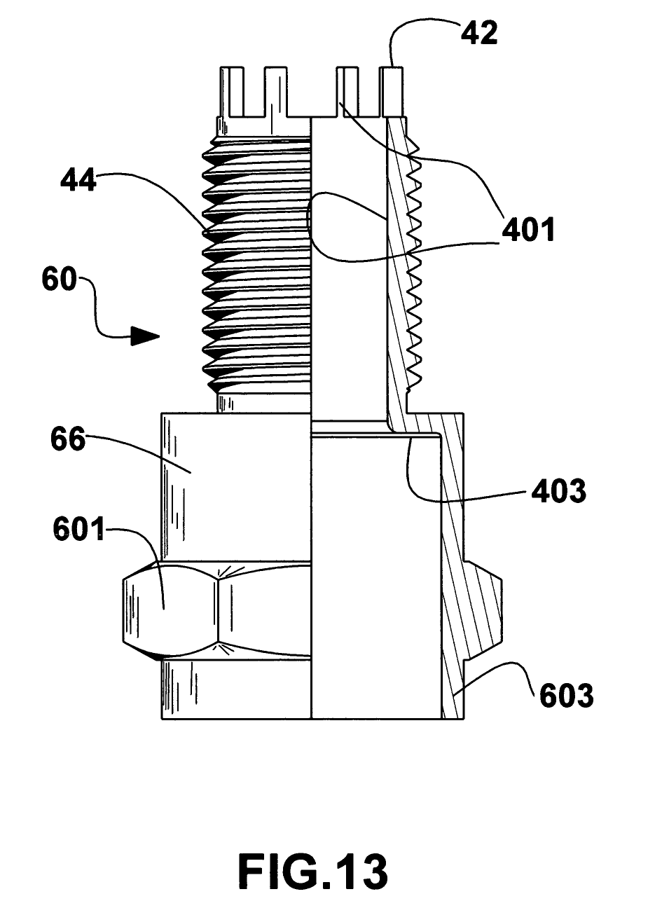

FIG. 13 is a front partial cross cut view of the ground sleeve.

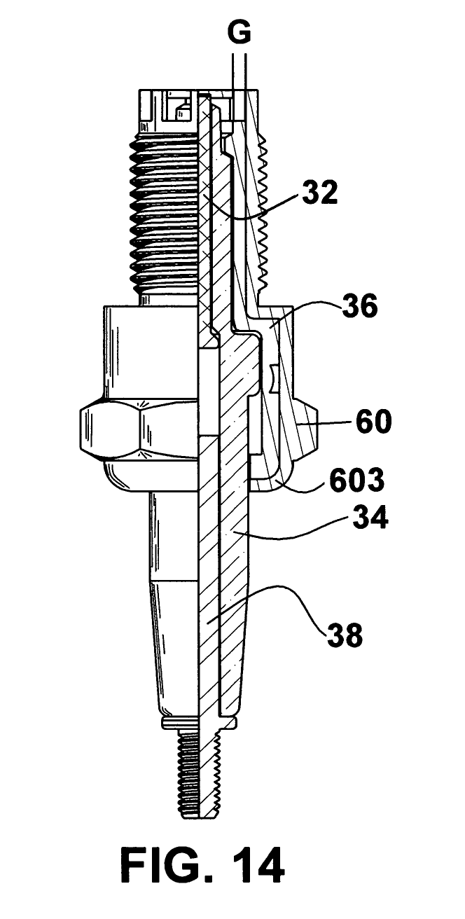

FIG. 14 is a front partial cross cut view of the primary shell and insulator assembly and the ground sleeve after assembly.

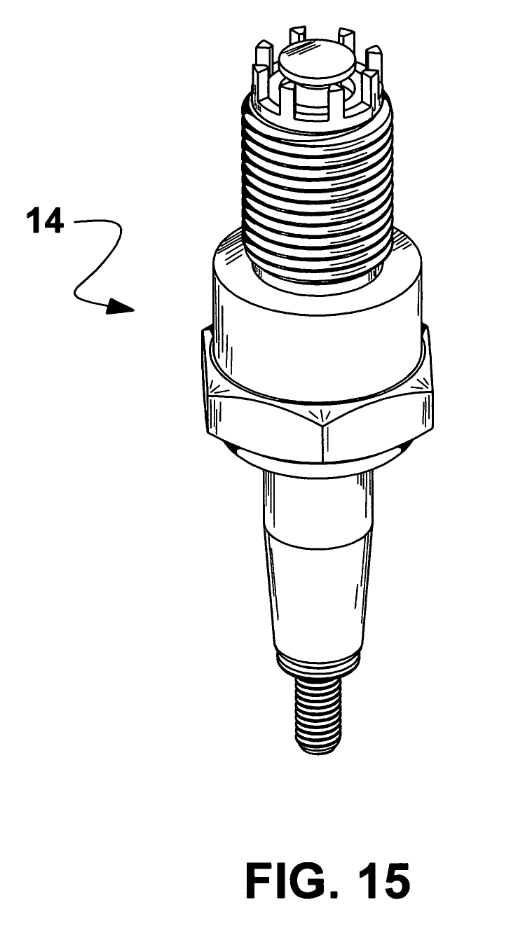

FIG. 15 is a perspective view of the preferred embodiment in its final state.

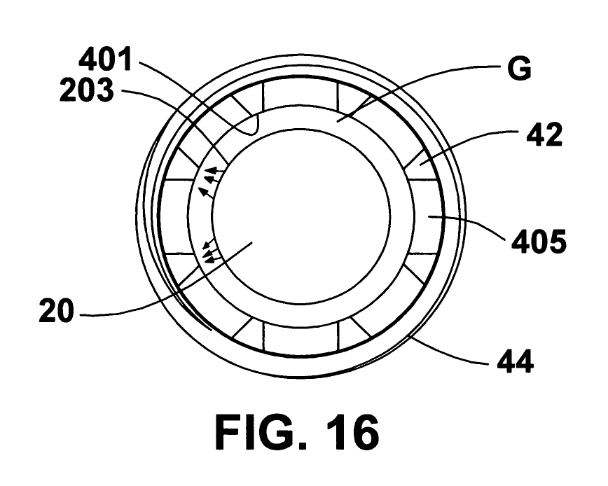

FIG. 16 is a top view of the firing end configuration.

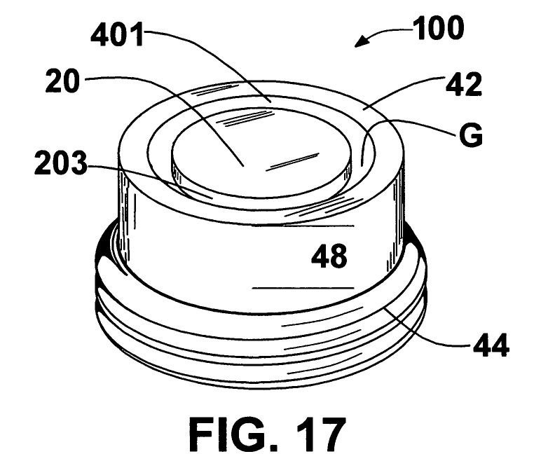

FIG. 17 is a partial perspective view of the firing end configuration example of the preferred embodiments.

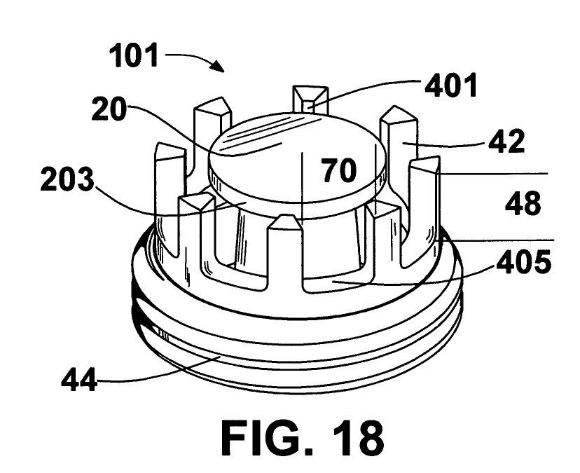

FIG. 18 is a partial perspective view of the firing end configuration example 101, of the preferred embodiments.

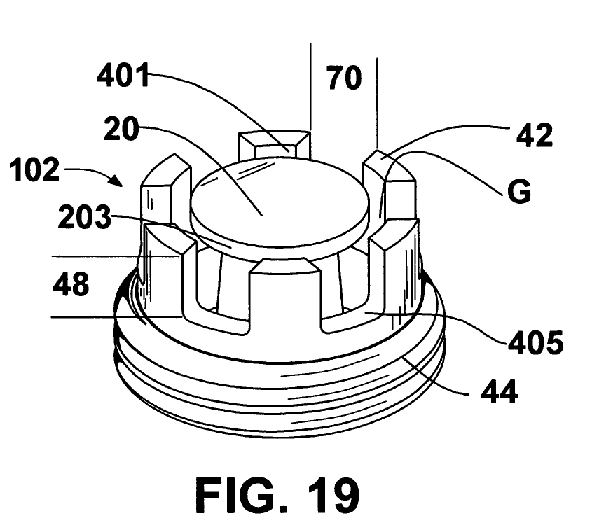

FIG. 19 is a partial perspective view of the firing end configuration example 102, of the preferred embodiments.

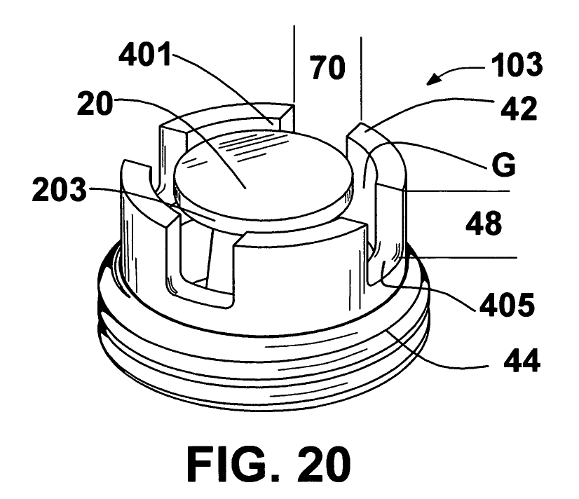

FIG. 20 is a partial perspective view of the firing end configuration example 103, of the preferred embodiments.

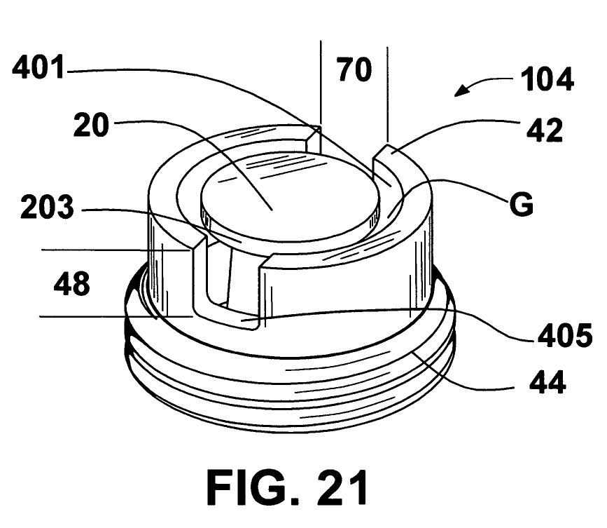

FIG. 21 is a partial perspective view of the firing end configuration example 104, of the preferred embodiments.

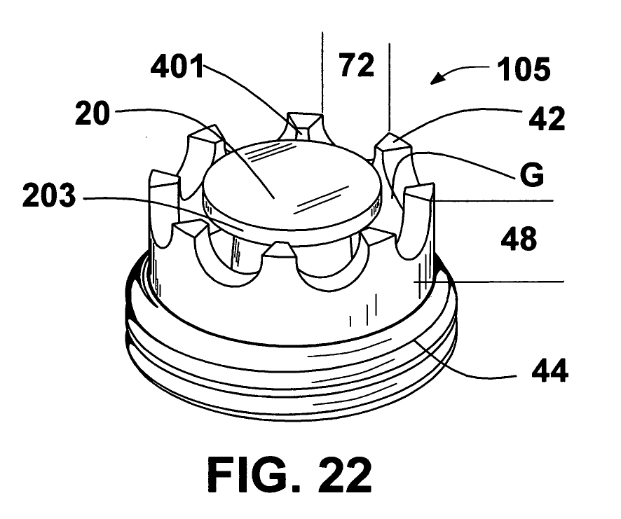

FIG. 22 is a partial perspective view of the firing end configuration example 105, of the preferred embodiments.

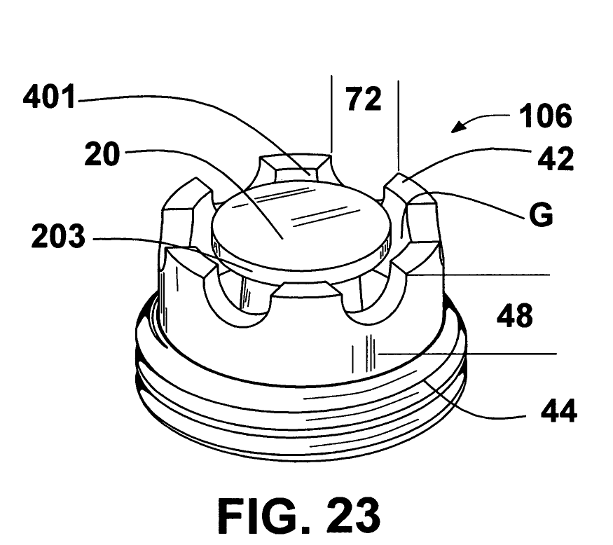

FIG. 23 is a partial perspective view of the firing end configuration example 106, of the preferred embodiments.

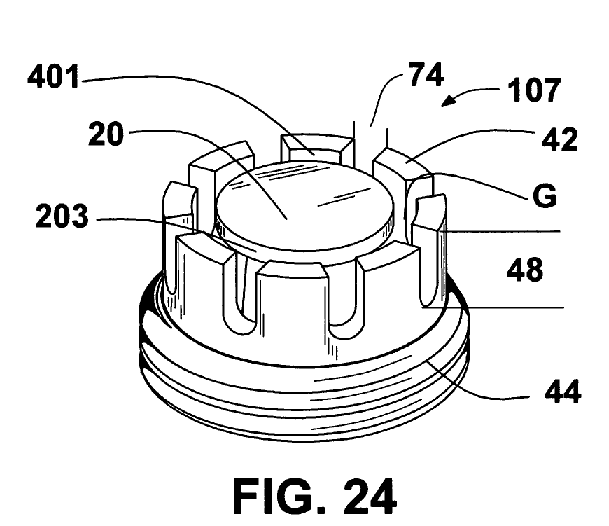

FIG. 24 is a partial perspective view of the firing end configuration example 107, of the preferred embodiments.

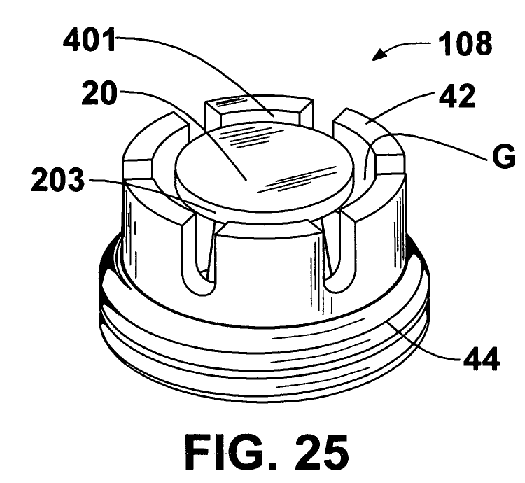

FIG. 25 is a partial perspective view of the firing end configuration example 108, of the preferred embodiments.

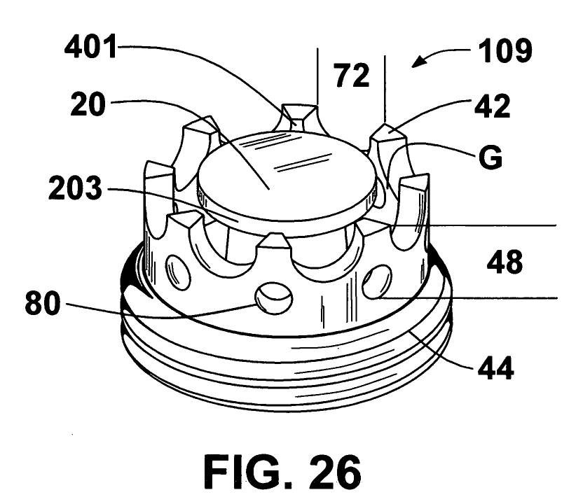

FIG. 26 is a partial perspective view of the firing end configuration example 109, of the preferred embodiments.

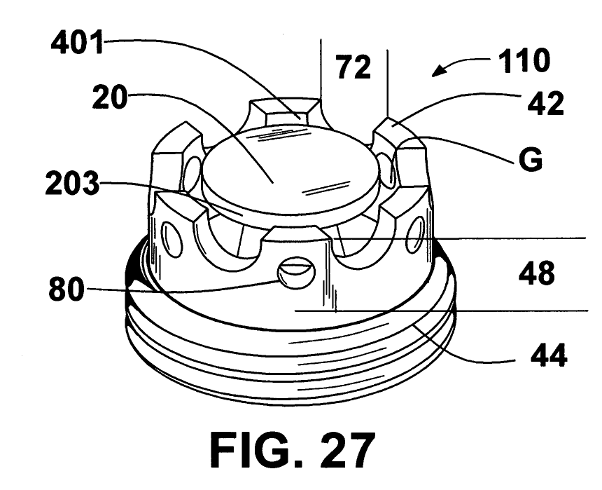

FIG. 27 is a partial perspective view of the firing end configuration example 110, of the preferred embodiments.

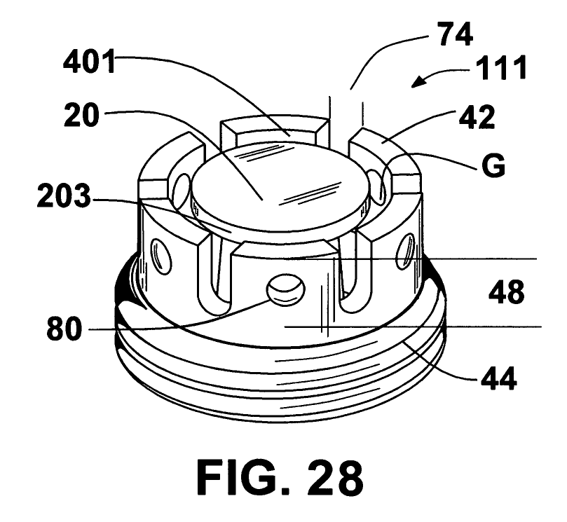

FIG. 28 is a partial perspective view of the firing end configuration example 111, of the preferred embodiments.

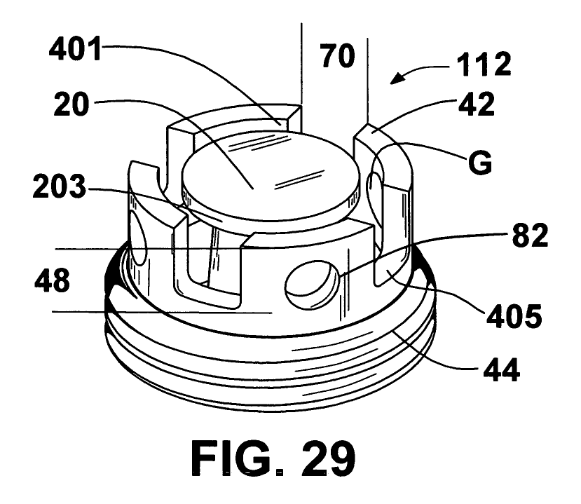

FIG. 29 is a partial perspective view of the firing end configuration example 112, of the preferred embodiments.

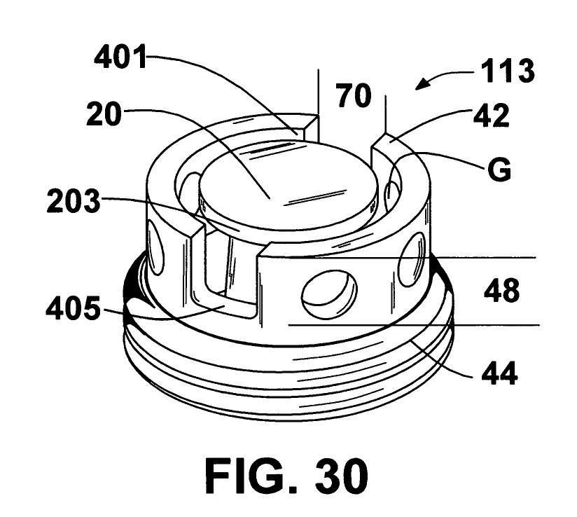

FIG. 30 is a partial perspective view of the firing end configuration example 113, of the preferred embodiments.

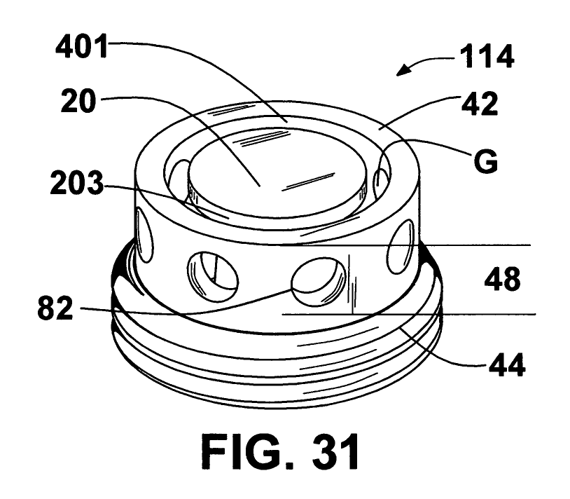

FIG. 31 is a partial perspective view of the firing end configuration example 114, of the preferred embodiments.

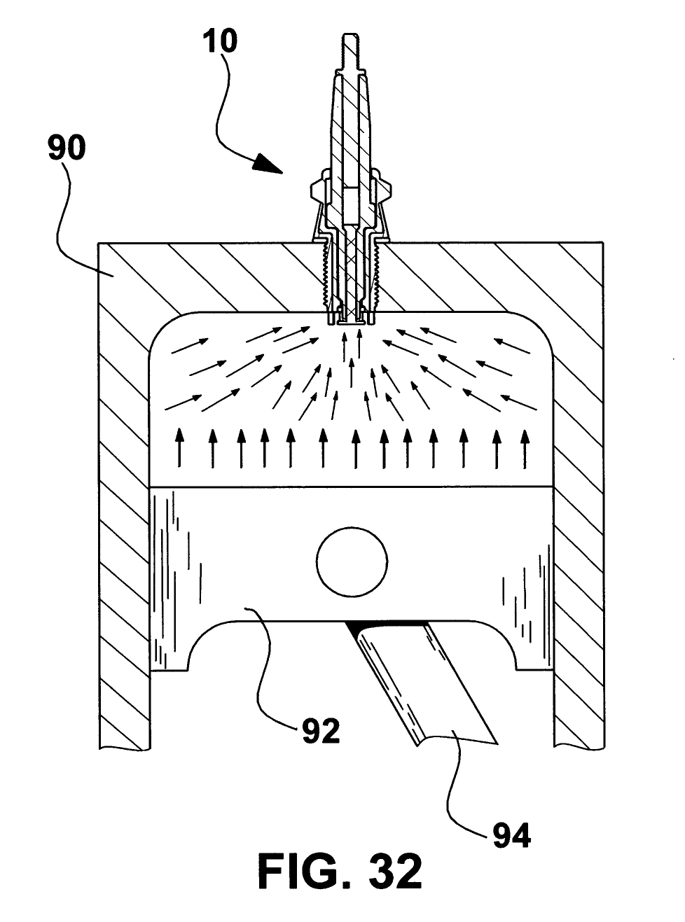

FIG. 32 is a frontal view of the cylinder showing the piston in relation to the sparkplug and the compressing of the air fuel mixture.

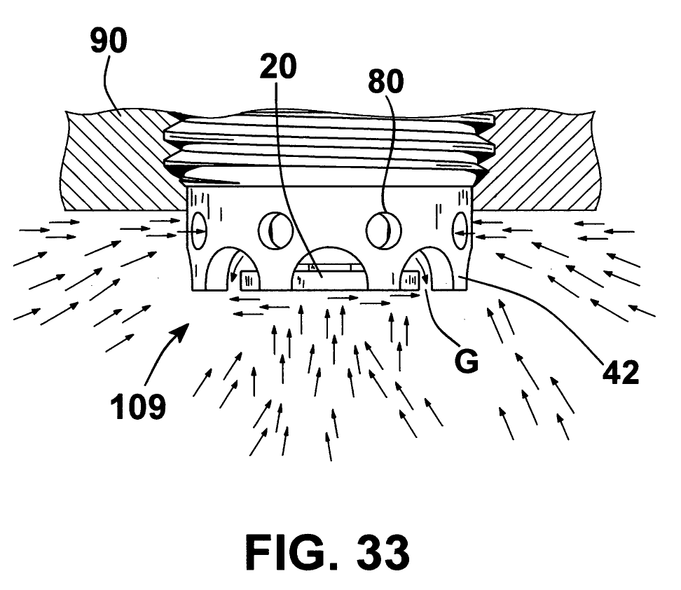

FIG. 33 is a frontal cut away view of the cylinder showing the intended flow of the air fuel mixture in and around the firing surfaces of the electrode and grounding prongs.

DRAWINGS - Reference Numerals

| | |
|---|---|
| 10 | Preferred embodiment 1 |
| 12 | Preferred embodiment 2 |
| 14 | Preferred embodiment 3 |
| 20 | Electrode donut |
| 201 | Hole in the center of the electrode |
| | donut |
| 203 | Firing surface of the electrode |
| | donut |
| 30 | Primary shell and Insulator |
| | assembly |
| 32 | The core electrode |
| 34 | Insulator |
| 36 | Primary shell |
| 361 | Barrel portion of primary shell |
| 363 | Primary shoulder surface |
| 365 | Mounting nut |
| 367 | Surface area |
| 38 | Terminal |
| 40 | Ground sleeve |
| 401 | Surface area inside ground sleeve |
| 403 | Mating surface |
| 405 | Surface at head threshold |
| 42 | Ground prongs |
| 44 | The mounting threads |
| 46 | The base |
| 48 | The depth of the protrusion of the |
| | prongs |
| 50 | Ground sleeve of second |
| | embodiment |
| 56 | Base of ground sleeve second |
| | embodiment |
| 60 | Ground sleeve of third embodiment |
| 66 | Base of ground sleeve of third |
| | embodiment |
| 601 | Mounting nut of third embodiment |
| 603 | Flange |
| 70 | Type 1 cut out |
| 72 | Type 2 cut out |
| 74 | Type 3 cut out |
| 80 | Type 1 port hole |
| 82 | Type 2 port hole |
| 84 | Type 3 port hole |
| 90 | Head |
| 92 | Piston |
| 94 | Piston rod |
| 100 | Example 1 of the firing end |
| | configurations |
| 101 | Example 2 of the firing end |
| | configurations |
| 102 | Example 3 of the firing end |
| | configurations |
| 103 | Example 4 of the firing end |
| | configurations |
| 104 | Example 5 of the firing end |
| | configurations |
| 105 | Example 6 of the firing end |
| | configurations |
| 106 | Example 7 of the firing end |
| | configurations |
| 107 | Example 8 of the firing end |
| | configurations |
| 108 | Example 9 of the firing end |
| | configurations |
| 109 | Example 10 of the firing end |
| | configurations |
| 110 | Example 11 of the firing end |
| | configurations |
| W1 | Weld 1 |
| W2 | Weld 2 |
| W3 | Weld 3 |
| G | Spark potential area |

### DETAILED DESCRIPTION

### First Embodiment

FIG. 1 shows the primary shell and insulator assembly 30, the primary shell 36, which is made of a metallic material and houses the insulator 34, which is made of a ceramic type material, and is used for the electrical isolation of the core electrode 32 and terminal 38, from the primary shell 36. The core electrode 32, terminal 38 and the primary shell 36, are assembled in the same fashion as a standard sparkplug. The terminal 38 is the high voltage connection to, the ignition coil. The mounting nut 365 is for tightening the sparkplug into the head of the internal combustion engine. The barrel portion surface 361 is a locating surface. At this stage, the diameter of the barrel portion surface 361 is at least 0.010″ larger than it will be at the time of assembly. Primary shoulder surface 363 is a locating surface and will be further machined as well. The electrode donut 20 is flat and disk shaped and is from 0.030″ to 0.065″ thick. The locating hole 201 is in the center of the electrode donut, and the diameter of the locating hole 201 is 0.002″ to 0.005″ larger than the diameter of the core electrode 32. The surface 203 is the firing surface. This is the surface that the spark jumps to from the ground. The diameter of firing surface 203 will constitute the size of the spark potential area, but at this stage it is at least 0.010″ larger than it will be at the time of assembly. The electrode donut 20 fits on to the core electrode 32 in the direction shown by the arrows and is permanently bonded to the core electrode 32 as weld W1, shown in FIG. 2.

FIG. 3 shows the ground sleeve 40, the mounting threads 44, the base 46, cylindrical surface 401, the mating surface 403, and the ground prongs 42. The mounting threads 44 are used to screw the sparkplug into the head of the internal combustion engine. The ground prongs 42 protrude up from the threaded portion and in to the combustion chamber of the internal combustion engine. Cylindrical surface 401 is the inside diameter of the ground sleeve 40 and the inside surface of the ground prongs 42.

After the electrode donut 20 is bonded to the core electrode 32 it will be machined so as to smooth polish the top surface 205 shown in FIG. 4. During this machining step firing surface 203 of the electrode donut 20 and barrel portion surface 361 of the primary shell 36 will be machined in the same step so as to make there diameters exactly concentric in respect to one another. Barrel portion surface 361 is machined so the diameter is from 0.001″ to 0.002″ larger than the diameter of cylindrical surface 401 of the ground sleeve 40. The diameter of firing surface 203 of the electrode donut 20 will determine the spark gap of the finished sparkplug. For example if you want a 0.040″ spark gap, the formula is; the diameter of cylindrical surface 401−(0.040″×2)=the diameter of the electrode donut 20, firing surface 203. Primary shoulder surface 363 will also be machined in this process so as to make it precisely perpendicular to the center line of those diameters and parallel with top surface 205 of the electrode donut 20.

After the primary shell and insulator assembly 30, and the electrode donut 20 have been bonded, and machined, the ground sleeve 40 will be pressed on to the primary shell 36 in the direction shown by the arrows in FIG. 4. The larger diameter of barrel portion surface 361 will make it a very tight fit, so for this process the ground sleeve 40 may be heated to temporarily expand diameter of cylindrical surface 401 and make the press easier. The ground sleeve 40 is pressed on until mating surface 403 comes in contact with mating surface 363 of the primary shell 36, shown in FIG. 5. That will put firing surface 203 of the electrode donut 20 directly across from surface area 401 of the ground prongs 42. The area between these two surfaces is the spark potential area G, or the spark gap as it is more commonly called. These areas are where the spark can happen.

After ground sleeve 40 is pressed into place it will be permanently attached around the base 46 so as to permanently bond it to the primary shell 36, shown in FIG. 6, as W2. After the ground sleeve 40 is welded to the primary shell 36, the weld W2 will be machined so as to be smooth and polished as shown in FIG. 7 as the preferred embodiment 10 in its final form.

### Second Embodiment

Ground sleeve 50, in FIG. 8, is pressed on to the primary shell 36 in the same fashion as ground sleeve 40, as shown and described in FIG. 4. The variation of the base 56 extends down so as to come in close proximity with the surface area 367 of the primary shell 36, as shown in FIG. 9. After the ground sleeve 50 is pressed into place it is welded to the primary shell 36 at surface 367 filling the proximal area between base 56 and surface 367 and extending around the circumference, shown in FIG. 10 as W3. After the ground sleeve 50 is welded to the primary shell 36, the weld W3 will be machined so as to be smooth and polished as shown in FIG. 11 as the preferred embodiment 12 in its final form.

### Third Embodiment

The mounting nut 365 of the primary shell 36 has been omitted as shown in FIG. 12. The third embodiment uses ground sleeve 60, shown in FIG. 13. Ground sleeve 60, is pressed on to the primary shell 36 in the same fashion as ground sleeve 40, as shown and described in FIG. 4. The variation of the base 66 extends down to include the mounting nut 601 and flange 603. After ground sleeve 60 is pressed into place flange 603 will be bent in, up and around the bottom portion of primary shell 36 as shown in FIG. 14. This method requires no welding. FIG. 15 shows preferred embodiment 14 in its final form.

FIG. 16 shows a top view of the firing end, the little arrows show how the electromotive force from the ignition coil radiates out from firing surface 203 of the positive electrode 20 to establish an ionization path to ground, that is surface area 401 of the prongs 42, so that the electrons can flow though the ionization path, and the compressed air fuel mixture like they would do though a solid wire. When the electrons flow, they are very hot so as to ignite the air fuel mixture. This happens in less than 0.001 of a second, the faster the better. The combustion chamber environment is very turbulent do to the compressing of the air fuel mixture, as shown by the little arrows in FIG. 32, this happens inside the cylinder 90. During the compression, the air fuel mixture is being smashed, and squeezed, by the piston 92 that connects to the piston rod 94, in the direction of the sparkplugs firing end blowing the ionization path out several times before it can be established. So having multiple points, and more spark potential area G, is very beneficial, this is why the spark potential area G must be exactly the same physical distance as one another so as not to have any physical bias. This will give the ionization a path of least resistance based on the flow of the air fuel mixture at the precise time of the firing as seen in FIG. 33.

FIG. 17-FIG. 31 shows prime examples of what we are trying to achieve with the flow of the air fuel mixture, to help establish the ionization path, by pushing it in the direction of the ground prongs 42, but do to the fact that the environment is so turbulent it may only do this in one, two or three areas, but it only needs one at a time. This will greatly improve the performance of the sparkplug which in turn will improve the performance of the internal combustion engine.

To determine the exact characteristics of the firing end we use formulas based on the diameter of the ground sleeve cylindrical surface 401 of FIG. 3 that is the distance across the top between the prongs 42 and is the base dimension to determine the characteristics of the spacing of the prongs 42, with cut outs 70, 72, 74, and the port holes 80, 82.

For example purposes we use the standard size 14 mm, but can achieve the same characteristics for 18 mm, 12 mm and 10 mm applications these are also common sizes for sparkplugs but would have different base dimensions.

FIG. 17 shows example 100. This has no port holes and no cut outs. To determine the depth 48 that the firing end will protrude into the combustion chamber we use the base dimension for a 14 mm sparkplug which is 0.375″. The formula is 0.375/3=0.125″. If we need to go deeper we use a smaller divisor. The depth 48 is added to the reach of the sparkplug, which is the distance from the base 46 to surface 405 of the ground sleeve 40 as shown in FIG. 6. Surface 405 is the threshold into the firing cylinder.

FIG. 18 shows example 101. This has 8 cut outs 70 and no port holes. The depth of the cut outs 70 in example 101, go to the surface of 405 so that would make it 0.375/3-0.125″ deep, if we need to go shallower we use a smaller divisor. The formula for the width of the cut outs 70 are based on the 0.375″ diameter as well. This is 0.375/3=0.125″. The cut outs 70 are spaced evenly around the ground sleeve 40 in 8 places as shown in FIG. 18.

FIG. 19 shows example 102. This has 6 cut outs 70 and no port holes. The cut outs are the same as example 102 except that there are 6. As you can see this changes the characteristics of the prongs 42.

FIG. 20 shows example 103. This has 4 cut outs 70 and no port holes.

FIG. 21 shows example 104. This has 2 cut outs 70 and no port holes.

FIG. 22 shows example 105. This has 8 cut outs 72 and no port holes. The cut outs 72 are different so as to be completely round. The formula for this is, the base dimension which is 0.375″ is 0.375/3×0.5=0.0625″ radius. So the widths of the cut outs 72 are 0.125″ and is basically a half hole, with the center at the end of the prongs 42 so that the bottom of the radios is half of the depth 48. These are spaced evenly around the ground sleeve 40 in 8 places as well.

FIG. 23 shows example 106, this has 6 cut outs 72 and no port holes.

FIG. 24 shows example 107, this has 8 cut outs 74 and no port holes. The cut outs 74 are different so as to be thinner and round at the bottom. The formula for this is, the base dimension which is 0.375″ is 0.375/6=0.0625″. So the widths of the cut outs 74 are 0.0625″. These are spaced evenly around the ground sleeve 40 in 8 places as well.

FIG. 25 shows example 108. This has 6 cut outs 74 and no port holes.

FIG. 26 shows example 109. This has 8 cut outs 72 and 8 port holes 80. The port holes are located directly under the prongs 42 and are located so that the bottom of the port hole 80 is at the threshold of the depth 48. The size of the port holes 80 are determined by the base dimension of 0.375″ as well. Which is 0.375/6=0.0625, the diameter of port hole 80. These are spaced evenly around the ground sleeve 40 in 8 places as described as well.

FIG. 27 shows example 110. This has 6 cut outs 72 and 6 port holes 80. The port holes are located directly in the center of the prongs and in the center of the depth 48. These are spaced evenly around the ground sleeve 40 in 8 places as described as well.

FIG. 28 shows example 111. This has 6 cut outs 74 and 6 port holes 80.

FIG. 29 shows example 112. This has 4 cut outs 70 and 4 port holes 82. The port holes 82 are larger and are located in the center of the prongs 42 with the bottom at the threshold of the depth 48. The size of the port holes 82 are determined by the base dimension of 0.375″ as well. Which is 0.375/4=0.0938, the diameter of port hole 82. These are spaced evenly around the ground sleeve 40 in 4 places as described as well.

FIG. 30 shows example 113. This has 2 cut outs 70 and 6 port holes 82. As shown.

FIG. 31 shows example 114. This has no cut outs and 8 port holes 82. As shown.

The multiple sparkplugs are different only in the fact that they are designed to perform with in the realms of a specific application but can still be used in an enormous number of applications and other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although they are different in appearance, and have variations of there design they are all, manufactured and assembled, to perform in the true spirit and scope of the invention.

Having thus described the invention, what is desired to be protected by Letters Patent is presented in the subsequently appended claims.

What is claimed is:

1. A sparkplug for the internal combustion engine comprising:
a. a terminal end and a firing end,
b. a primary shell and insulator assembly,
c. said primary shell and insulator assembly further comprising a center core electrode, an insulator that raps around said center core electrode concentrically, letting the firing end of said core protrude out from said insulator at said firing end, and letting the terminal end of said center core electrode protrude out from said terminal end, and the primary shell that raps around said insulator concentrically,
d. an electrode donut that raps around said center core electrode concentrically, at the point were it protrudes out from said insulator at said firing end,
e. said electrode donut further being permanently attached,
f. a ground sleeve that presses on to, so as to rap around said primary shell of said primary shell and insulator assembly and said electrode donut precisely concentric, creating the spark potential areas between said ground sleeve and said electrode donut,
g. said spark potential areas further being a determined and precise physical distance, said ground sleeve further being permanently attached.

2. The sparkplug of claim 1, wherein said primary shell further comprises:
a. a primary shoulder,
b. a barrel portion that protrudes from said primary shoulder in the direction of said firing end at a determined length.

3. The sparkplug of claim 2, wherein said ground sleeve further comprises;
a. a base,
b. mounting threads,
c. and a cylindrical locating surface.

4. The sparkplug of claim 1, wherein said primary shell further comprises:
a. a primary shoulder,
b. a barrel portion that protrudes from said primary shoulder in the direction of the firing end at a determined length.

5. The sparkplug of claim 4, wherein said ground sleeve further comprises;
a. a base,
b. mounting threads,
c. a cylindrical locating surface,
d. and a mounting nut.

6. The sparkplug of claim 1, wherein said ground sleeve further comprises port holes that are a predetermined size and location.

7. A sparkplug for the internal combustion engine comprising:
a. a terminal end and a firing end,
b. a primary shell and insulator assembly,
c. said primary shell and insulator assembly further comprising a center core electrode, an insulator that raps around said center core electrode concentrically, letting said firing end protrude out from said insulator at said firing end, and letting said terminal end of said center core electrode protrude out from said terminal end, and the primary shell that raps around said insulator concentrically,
d. an electrode donut that raps around said center core electrode concentrically, at the point were it protrudes out from said insulator at said firing end,
e. said electrode donut further being permanently attached,
f. a ground sleeve that presses on to, so as to rap around said primary shell of said primary shell and insulator assembly precisely concentric,
g. said ground sleeve further comprising ground prongs that protrude in the direction of said firing end so as to line up radial around said electrode donut creating the spark potential areas between said ground sleeve and said electrode donut,
h. said spark potential areas further being a determined and precise physical distance.
i. said ground sleeve further being permanently attached.

8. The sparkplug of claim 7, wherein said primary shell further comprises:
a. a mounting nut,
b. a primary shoulder,
c. a barrel portion that protrudes from the primary shoulder in the direction of said firing end at a determined length.

9. The sparkplug of claim 8, wherein said ground sleeve further comprises:
a. a base,
b. mounting threads,
c. and a cylindrical locating surface.

10. The sparkplug of claim 7, wherein said primary shell further comprises:
a. a primary shoulder,
b. a barrel portion that protrudes from the primary shoulder in the direction of the firing end at a determined length.

11. The sparkplug of claim 10, wherein said ground sleeve further comprises;
a. a base,
b. mounting threads,
c. and a cylindrical locating surface,
d. and a mounting nut.

12. The sparkplug of claim 7, wherein said ground prongs are separated by cut outs that are a predetermined size and location.

13. The sparkplug of claim 12, wherein said ground prongs further comprise port holes that are a predetermined size and location.

14. A method for manufacturing a sparkplug comprising the steps:
a. machining step 1, machining the firing surface of the electrode donut, and the barrel portion in the same step there by making there surface diameters exactly concentric respectfully to one another,
b. machining step 2, machining the ground sleeve there by making the diameter of the cylindrical surface 0.001″ to 0.002″ respectively smaller to said diameter of said barrel portion in machining step 1, machining step 2, further comprises making said cylindrical surface and the inside surface of the ground prongs the same surface,
c. assembly step 1, sliding said ground sleeve, of machining step 2, on to said barrel portion of machining step 1, this being from the direction of the firing end to the terminal end, there by making said firing surface of said electrode donut exactly concentric respectively to said inside surface of said ground prongs,
d. assembly step 2, permanently bonding said ground sleeve to the primary shell of the primary shell and insulator assembly,
where by being the means of making the spark potential areas, or spark gaps, an exact physical predetermined distance respectively to one another.

15. The method of claim 14, where in said machining step 2 further comprises:
a. machining the port holes in said ground sleeve to a predetermined size and location there by making them perpendicular respectively to the center line of said sparkplug,
where in the said port holes are the means to direct the rapidly flowing air fuel mixture in a predetermined direction.

16. The method of claim 14 where in said machining step 2 further comprises:
a. machining the cut outs to a predetermined size, shape and location, making spaces in said ground surface of said ground prongs.
where in the said cut outs are the means to direct the rapidly flowing air fuel mixture in a predetermined direction,

17. The method of claim 14 where in said machining step 1 further comprises:
a. machining the firing surface of said electrode donut to a predetermined size,
where in is the means to determine the physical distance of said firing surface of said electrode donut respectively to said inside surface of said ground prongs.
